(19) United States
(12) Patent Application Publication
(10) Pub. No.: US 2024/0114463 A1
(43) Pub. Date: Apr. 4, 2024

(54) DETERMINING A LOCATION OF 6 GHZ WI-FI ACCESS POINT DEVICE FOR USE IN OBTAINING A TRANSMISSION POWER LEVEL

(71) Applicant: ARRIS Enterprises LLC, Suwanee, GA (US)

(72) Inventor: Paul A. CLANCY, Duluth, GA (US)

(21) Appl. No.: 18/375,615

(22) Filed: Oct. 2, 2023

Related U.S. Application Data
(60) Provisional application No. 63/412,591, filed on Oct. 3, 2022.

(51) Int. Cl. H04W 52/28; G01S 19/06; G01S 19/35; H04W 16/20; H04W 52/38; H04W 64/00

(52) U.S. Cl. CPC H04W 52/283; G01S 19/06; G01S 19/35; H04W 16/20; H04W 52/386; H04W 64/003

(57) ABSTRACT

A provisioning application can provide a location of an access point device so that the access point device can request provisioning of a transmit power level. The provisioning application can receive information from a user via user interface associated with the provisioning application, such as one or more location parameters, a height location, and/or an address associated with an access point device. The provisioning application provides a user with prompts and/or instructions for obtaining the information and for using an interact tool so as to indicate a boundary associated with the access point device. The one or more location parameters are updated or determined based on the boundary such that the location of the access point device can be accurately determined and transmitted to the access point device so as to be used by the access point device in receiving a transmission power level.

### BACKGROUND

Generally, a Wireless Fidelity (Wi-Fi) access point device, operating in the 6 Gigahertz (GHz) frequency band, defaults to using a low power transmission. The 6 GHz Wi-Fi access point device may use higher power transmission levels based upon results from querying an automated frequency coordination (AFC) system. As typically a 6 GHz Wi-Fi access point device is not permitted to operate using a channel that interferes with legacy 6 GHz wireless infrastructures, many 6 GHz Wi-Fi access point devices may only operate at a low power transmission due to missing location information. Therefore, there is a need to provide an enhanced Wi-Fi network experience for users by provisioning the access point device using accurate location information.

### SUMMARY

Given the various network activities that include substantial reliance on Internet access, especially indoor Wi-Fi or Internet access, and increased access to network resources, it is becoming imperative to provide the best optimized access to the network for all users and/or network devices seeking access to any number of network resources. A 6 GHz frequency band network can provide users of the network environment an option for a less crowded network and can enhance the quality of experience (QoE) of the users. In general, an access point device seeking to operate in the 6 GHz frequency band requires providing a transmission power level to the access point device based on a query to an AFC system. Such a query requires one or more location parameters associated with the network device, such as any of a latitude coordinate, a longitude coordinate, a vertical coordinate (for example, height above or below ground or sea level), a vertical or height uncertainty, any additional area information, or any combination thereof. The area or boundary information may be provided as an ellipse, a linear polygon or a radial polygon.

One or more novel solutions of the present disclosure provide an application that is used to allow a user to input location information associated with an access point device that is being provisioned to operate in the 6 GHz frequency band. The user can be prompted for any of an address associated with the access point device, a confirmation of a location of the access point device, an area or boundary associated with the location for the access point device, a location based on an interactive map, any other location parameter, or any combination thereof. By providing the user with an application to more precisely and accurately identify a location associated with the access point device, the access point device can be provisioned with a higher power transmission level and thus provide the user with an improved experience. Further, by utilizing standard hardware/software (such as a global positioning system (GPS), a barometer, triangulation, etc.) of a network device (for example, any of a mobile phone, a tablet, any device with cellular service, or any combination thereof), the costs associated with an access point device can be reduced as such do not need to be included within or as part of the network device.

An aspect of the present disclosure provides a method for determining a location associated with an access point device of a network. The method comprises determining an initial location associated with the client device, providing a visual representation of the initial location to a user, providing an interact tool for the user to indicate a new location and a boundary associated with the access point device on the visual representation, receiving the new location and the boundary based on user interaction with the interact tool of the visual representation, receiving a height location associated with the access point device, and providing the one or more location parameters to the access point device for obtaining a transmission power level, wherein the one or more location parameters are based on the new location, the boundary, and the height location.

In an aspect of the present disclosure, the method is such that the initial location comprises receiving an address from the user based on an address prompt, wherein at least one of the address is pre-filled and the address is filled in by the user.

In an aspect of the present disclosure, the method is such that the determining the initial location is based on one or more coordinates received from a GPS receiver of the client device.

In an aspect of the present disclosure, the method is such that the height location indicates any of a height above sea level, a height above ground, a depth below sea level, a depth below ground, a vertical uncertainty, or any combination thereof.

In an aspect of the present disclosure, the method further comprises at least one of determining that the new location is within a location threshold of the initial location, and determining that the client device is within a proximity threshold of the access point device.

In an aspect of the present disclosure, the method further comprises providing the interact tool to indicate a height location of the access point device.

In an aspect of the present disclosure, the method further comprises discovering one or more other access point devices of the network, and providing the one or more location parameters to the one or more other access point devices for obtaining a transmission power level.

An aspect of the present disclosure provides a network device for determining a location of an access point device of a network. The network device comprises a memory storing one or more computer-readable instructions and a processor configured to execute the one or more computer-readable instructions stored on the memory to cause the network device to determine an initial location associated with the client device, provide a visual representation of the initial location to a user, provide an interact tool for the user to indicate a new location and a boundary associated with the access point device on the visual representation, receive the new location and the boundary based on user interaction with the interact tool of the visual representation, receive a height location associated with the access point device, and provide the one or more location parameters to the access point device for obtaining a transmission power level, wherein the one or more location parameters are based on the new location, the boundary, and the height location.

In an aspect of the present disclosure, the determining the initial location comprises receiving an address from the user based on an address prompt, wherein at least one of the address is pre-filled and the address is filled in by the user.

In an aspect of the present disclosure, the determining the initial location is based on one or more coordinates received from a GPS receiver of the client device

In an aspect of the present disclosure, the height location indicates any of a height above sea level, a height above ground, a depth below sea level, a depth below ground, a vertical uncertainty, or any combination thereof.

In an aspect of the present disclosure, the processor is further configured to execute the one or more computer-readable instructions to cause the network device to determine that the new location is within a location threshold of the initial location, and determine that the client device is within a proximity threshold of the access point device.

In an aspect of the present disclosure, the processor is further configured to execute the one or more computer-readable instructions to cause the network device to provide the interact tool to indicate a height location of the access point device.

In an aspect of the present disclosure, wherein the processor is further configured to execute the one or more computer-readable instructions to cause the network device to discover one or more other access point devices of the network, and provide the one or more location parameters to the one or more other access point devices for obtaining a transmission power level.

An aspect of the present disclosure provides a non-transitory computer-readable medium for storing one or more instructions for providing one or more location parameters associated with an access point device of a network. The one or more instructions, that when executed by a processor, cause the processor to perform one or more operations including the steps of the methods described above.

The above-described network device(s) or electronic apparatus(es), such as access point devices, extender access point devices, client devices and any other network devices, may be implemented as any of a residential network access point device, an electronic device (for example, a mobile phone, a computing device such as a notebook computer, or both) according to some example embodiments.

Thus, according to various aspects of the present disclosure described herein, it is possible for a provisioning application to provide one or more location parameters to an access point device so that the access point device can obtain a power transmission level so as to utilize the 6 GHz frequency band without interfering with legacy systems within proximity of the access point device.

### BRIEF DESCRIPTION OF DRAWINGS

In the drawings, like reference numbers generally indicate identical, functionally similar, and/or structurally similar elements.

FIG. 1 is a schematic diagram of a network environment, according to one or more aspects of the present disclosure;

FIG. 2 is a more detailed block diagram illustrating various components of an exemplary access point device, client device, and extender access point device implemented in the network environment of FIG. 1, according to one or more aspects of the present disclosure;

FIG. 3 is a more detailed block diagram illustrating a network device for use in determining one or more location parameters associated with an access point device of a network, according to one or more aspects of the present disclosure;

FIGS. 4A-4G illustrate a user interface of a provisioning application for transmitting or sending one or more locations parameters to an access point device in a network environment, according to one or more aspects of the present disclosure; and

FIG. 5 is a flow chart illustrating a method for determining a location associated with an access point device of a network, according to one or more aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

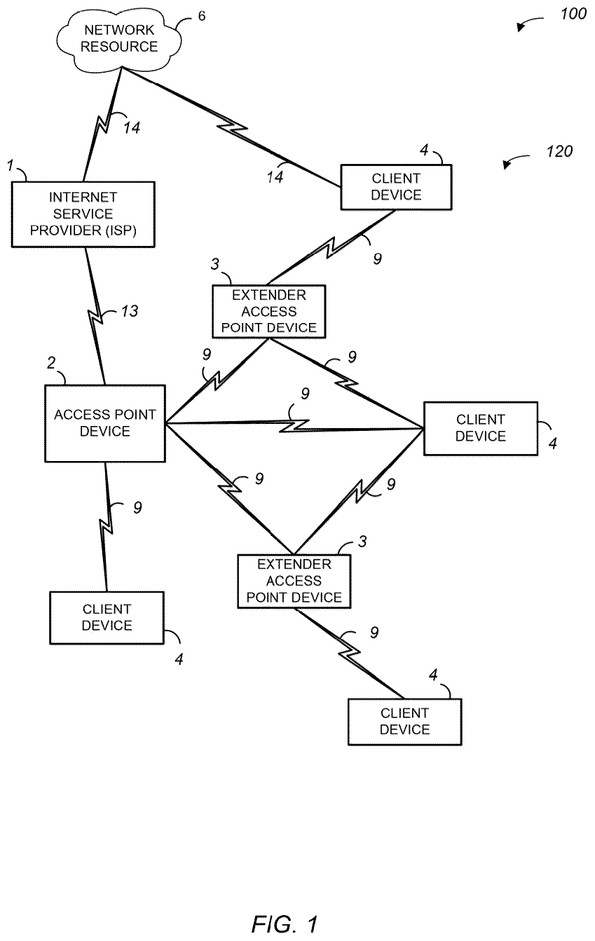

FIG. 1 is a schematic diagram of a network environment 100, according to one or more aspects of the present disclosure. It should be appreciated that various example embodiments of inventive concepts disclosed herein are not limited to specific numbers or combinations of devices, and there may be one or multiple of some of the aforementioned electronic apparatuses or network devices in the network environment, which may itself consist of multiple communication networks and various known or future developed wireless connectivity technologies, protocols, devices, and the like.

A network environment 100 comprises a network 120, an Internet Service Provider (ISP) 1 and a network resource 6. The network 120 comprises an access point device 2 connected to a network resource 6, such as a cloud-based repository, via an ISP 1 and also connected to different wireless devices or network devices such as one or more wireless extender access point devices 3 and one or more client devices 4. The network environment 100 shown in FIG. 1 includes wired and/or wireless network devices (for example, an access point device 2, one or more extender access point device 3 and one or more client devices 4) that may be connected in one or more wireless networks (for example, private, guest, iControl, backhaul network, or Internet of things (IoT) network) within the network environment 100. Additionally, there could be some overlap between network devices (for example, extender access point devices 3 and client devices 4) in the different networks. That is, one or more network or wireless devices could be located in more than one network. For example, the extender access point devices 3 could be located both in a private network for providing content and information to a client devices 4 and also included in a backhaul network or an iControl network.

The ISP 1 can be, for example, a content provider or any computer for connecting the access point device 2 to the network resource 6. For example, network resource 6 can be a cloud-based service that provides access to a cloud-based repository, a governmental or other database that provides information associated with operations within the 6 GHz wireless frequency band, a location service for providing topographical information, a network resource that provides provisioning information, any other repository, or any combination thereof that is accessible via ISP 1. In one or more embodiments, network resource 6 may be accessible via a cellular communications service provider so as to connect to a client device 4, such as a mobile phone, via a connection 14. The connection 14 between the network resource 6 and the ISP 1 and/or client device 4 and the connection 13 between the ISP 1 and the access point device 2 can be implemented using a wide area network (WAN), a virtual private network (VPN), metropolitan area networks (MANs), system area networks (SANs), a data over cable service interface specification (DOCSIS) network, a fiber optics network (for example, FTTH (fiber to the home) or FTTX (fiber to the x), or hybrid fiber-coaxial (HFC)), a digital subscriber line (DSL), a public switched data network (PSDN), a global Telex network, or a 2G, 3G, 4G, 5G, or 6G network, for example.

The connection 13 can further include as some portion thereof a broadband mobile phone network connection, an optical network connection, or other similar connections. For example, the connection 13 can also be implemented using a fixed wireless connection that operates in accordance with, but is not limited to, 3rd Generation Partnership Project (3GPP) Long Term Evolution (LTE), 5G, or 6G protocols. It is also contemplated by the present disclosure that connection 13 is capable of providing connections between the access point device 2 and a WAN, a LAN, a VPN, MANs, PANs, WLANs, SANs, a DOCSIS network, a fiber optics network (for example, FTTH, FTTX, or HFC), a PSDN, a global Telex network, or a 2G, 3G, 4G, 5G or 6G network, for example.

The access point device 2 can be, for example, any network device that is capable of being configured to operate and/or operating using a 6 GHz frequency band, such as any 6 GHz Wi-Fi device, an access point and/or a hardware electronic device that may be a combination modem and gateway that combines the functions of a modem, an access point (AP), and/or a router for providing content received from the ISP 1 to one or more network devices (for example, wireless extender access point devices 3 and client devices 4) in the network 120. In one or more embodiments, the access point device 2 is provisioned based on a power transmission level based on one or more location parameters associated with the access point device 2 so as to provide a 6 GHz wireless frequency band network for one or more network devices connected to the access point device 2, for example, any one or more client devices 4 connected directly and/or indirectly to the access point device 2. It is also contemplated by the present disclosure that the access point device 2 can include the function of, but is not limited to, a universal plug and play (UPnP) simple network management protocol (SNMP), an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content. The access point device 2 may also be referred to as a residential gateway, a home network gateway, or a wireless access point (AP).

The connection 9 between the access point device 2, the wireless extender access point devices 3, and client devices 4 can be implemented using a wireless connection in accordance with any IEEE 802.11 Wi-Fi protocols, Bluetooth protocols, BLE, or other short range protocols that operate in accordance with a wireless technology standard for exchanging data over short distances using any licensed or unlicensed band such as the citizens broadband radio service (CBRS) band, 2.4 GHz bands, 5 GHz bands, 6 GHz bands, or 60 GHz bands. Additionally, the connection 9 can be implemented using a wireless connection that operates in accordance with, but is not limited to, RF4CE protocol, ZigBee protocol, Z-Wave protocol, or IEEE 802.15.4 protocol. It is also contemplated by the present disclosure that the connection 9 can include connections to a media over coax (MoCA) network. One or more of the connections 9 can also be a wired Ethernet connection. Any one or more of connections 9 can carry information on any of one or more channels that are available for use.

The one or more extender access point devices 3 can be, for example, wireless hardware electronic devices such as access points (APs), extenders, repeaters, etc. used to extend the wireless network by receiving the signals transmitted by the access point device 2 and rebroadcasting the signals to, for example, one or more client devices 4, which may be out of range of the access point device 2. The one or more extender access point devices 3 can also receive signals from the one or more client devices 4 and rebroadcast the signals to the access point device 2, or other one or more client devices 4.

The one or more client devices 4 can be, for example, any network device capable of communicating with an access point device 2 and/or an extender access point device 3 and executing a provisioning application for determining one or more location parameters associated with a network device that requires provisioning. A client device 4 can comprise a hand-held computing device, a personal computer, an electronic tablet, a mobile phone, a smart phone, an Internet-of-Things (IoT) device, an iControl device, cellular networks, and interconnecting with other devices via Wi-Fi and/or Bluetooth, or any other wireless hand-held consumer electronic device capable of accessing a wireless network. For example, any one or more client devices can be a mobile network device capable of connecting to a wireless network and providing a network device, such as an access point device 2, with one or more location parameters so as to obtain a power transmission level for the access point device 2 to provide a 6 GHz wireless frequency band network. Additionally, any one or more client devices 4 can be a television (TV), an IP/QAM set-top box (STB) or a streaming media decoder that is capable of decoding audio/video content, and playing OTT or MSO provided content received through the access point device 2. The connection 9 between any of the one or more client devices 4 and one or more other network devices can be any type of wired and/or wireless connection.

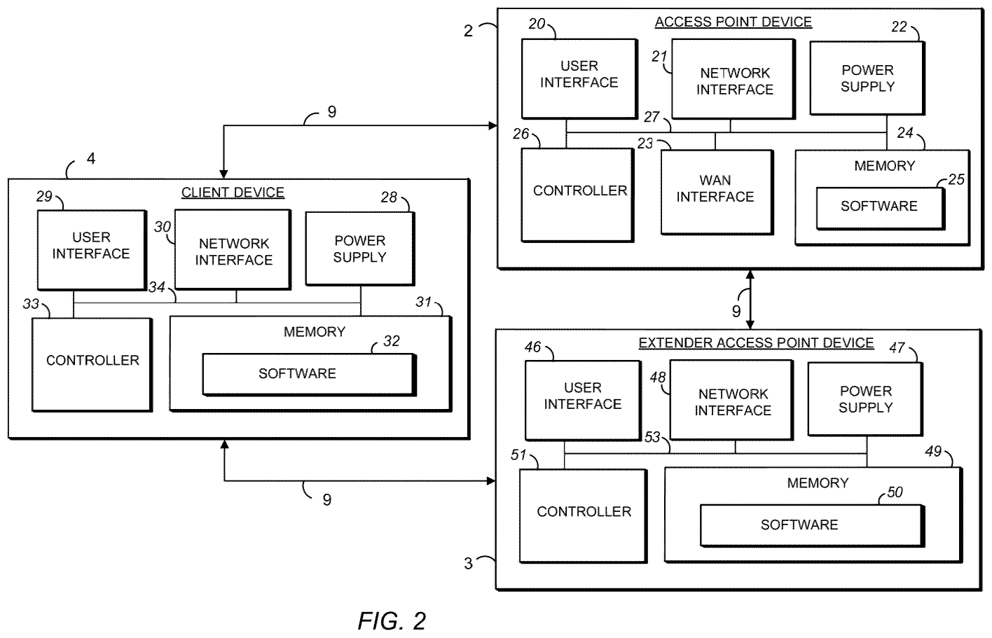

A detailed description of the exemplary internal components of the access point device 2, the one or more extender access point devices 3, and the one or more client devices 4 shown in FIG. 1 will be provided in the discussion of FIG. 2. However, in general, it is contemplated by the present disclosure that the access point device 2, the one or more extender access point devices 3, and the one or more client devices 4 include electronic components or electronic computing devices operable to receive, transmit, process, store, and/or manage data and information associated with the network environment 100, which encompasses any suitable processing device adapted to perform computing tasks consistent with the execution of computer-readable instructions stored in a memory or a computer-readable recording medium (for example, a non-transitory computer-readable medium).

Further, any, all, or some of the computing components in the access point device 2, the one or more extender access point devices 3, and the one or more client devices 4 may be adapted to execute any operating system, including Linux, UNIX, Windows, MacOS, DOS, and Chrome OS as well as virtual machines adapted to virtualize execution of a particular operating system, including customized and proprietary operating systems. The access point device 2, the one or more extender access point devices 3, and the one or more client devices 4 are further equipped with components to facilitate communication with other computing devices or network devices over the one or more network connections to local and wide area networks, wireless and wired networks, public and private networks, and any other communication network enabling communication in the network environment 100.

FIG. 2 is a more detailed block diagram illustrating various components of one or more exemplary network devices such as an access point device 2, a client device 4, and a wireless extender access point device 3 implemented in the network environment 100 of FIG. 1, according to one or more aspects of the present disclosure.

Although FIG. 2 only shows one extender access point device 3 and one client device 4, the extender access point device 3 and the client device 4 shown in the figure are meant to be representative of the other extender access point devices 3 and client devices 4 of a network system, for example, network environment 100 shown in FIG. 1. Similarly, the connections 9 between the access point device 2, the extender access point device 3, and the client device 4 shown in FIG. 2 are meant to be exemplary connections and are not meant to indicate all possible connections between the access point devices 2, extender access point devices 3, and client devices 4. Additionally, it is contemplated by the present disclosure that the number of access point devices 2, extender access point devices 3, and client devices 4 is not limited to the number of access point devices 2, extender access point devices 3, and client devices 4 shown in FIGS. 1 and 2.

The client device 4 can be, for example, any network device capable of executing a provisioning application for provisioning or determining a location of a 6 GHz Wi-Fi access point device 2. The client device can be any of a computer, a portable device, an electronic tablet, an e-reader, a PDA, a mobile phone such as a smart phone, an IoT device, an iControl device, cellular networks, interconnecting with any other one or more devices via Wi-Fi and/or Bluetooth, or any other one or more wireless hand-held consumer electronic device capable of communicating with access point device 2, a network resource 6 or any other network device. In one or more embodiments, a client device 4 is a mobile network device, such as a smart phone, capable of executing software, such as a provisioning application that comprises one or more computer-readable instructions.

The client device 4 includes a power supply 28, a user interface 29, a network interface 30, a memory 31, and a controller 33. The power supply 28 supplies power to the internal components of the client device 4 through the internal bus 34. The power supply 28 can be a self-contained power source such as a battery pack with an interface to be powered through an electrical charger connected to an outlet (e.g., either directly or by way of another device). The power supply 28 can also include a rechargeable battery that can be detached allowing for replacement such as a nickel-cadmium (NiCd), nickel metal hydride (NiMH), a lithium-ion (Li-ion), or a lithium Polymer (Li-pol) battery.

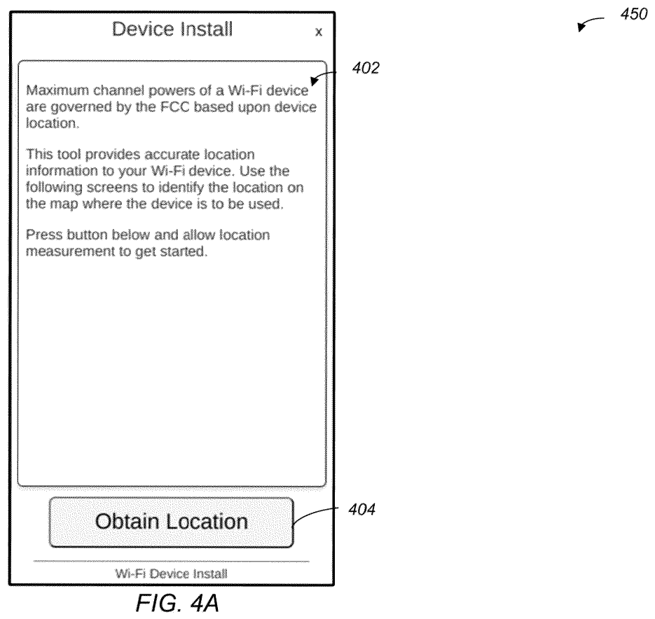

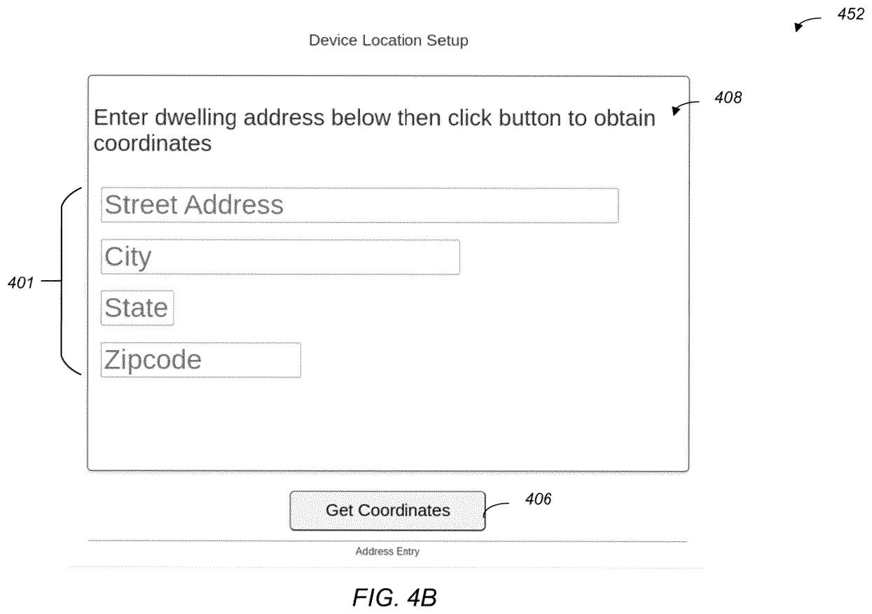

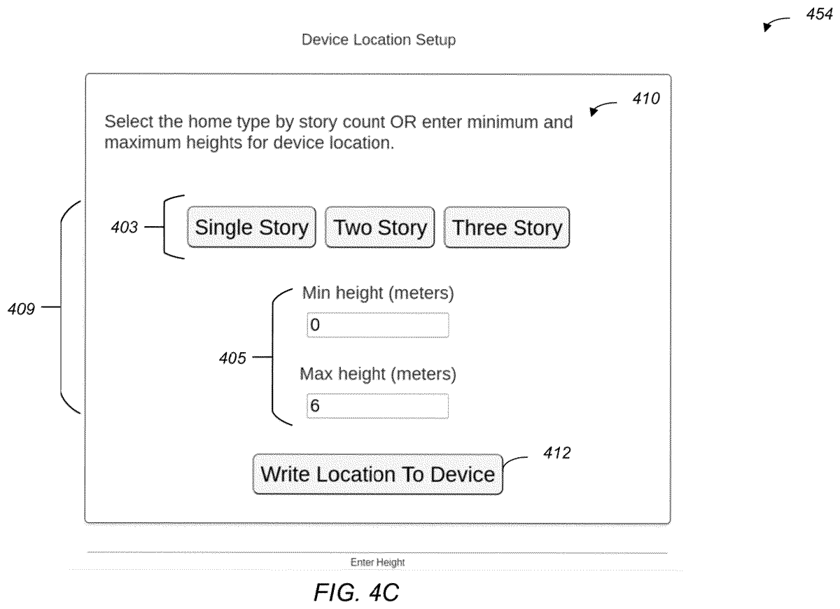

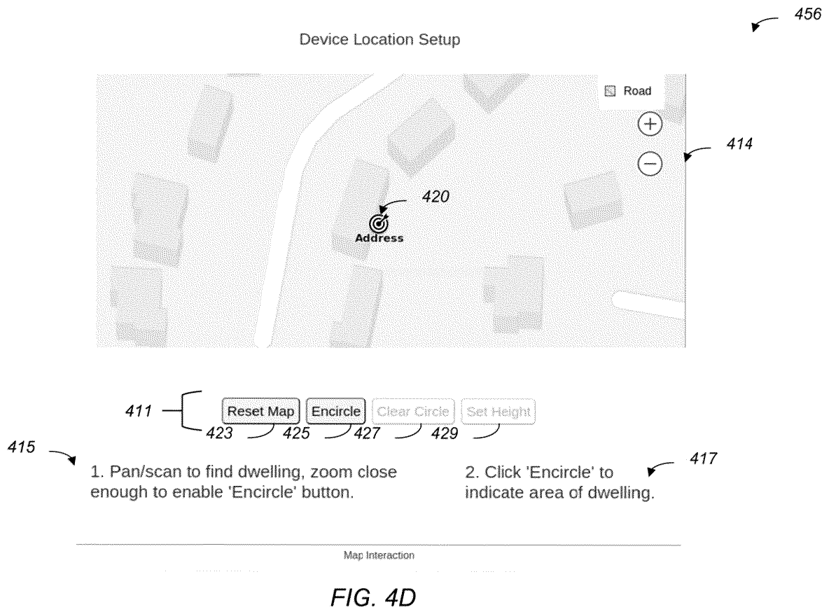

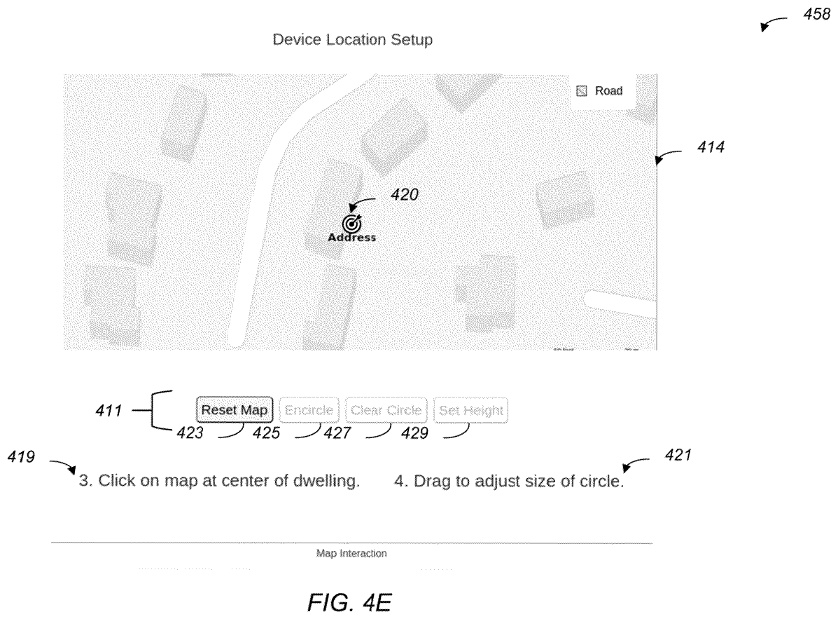

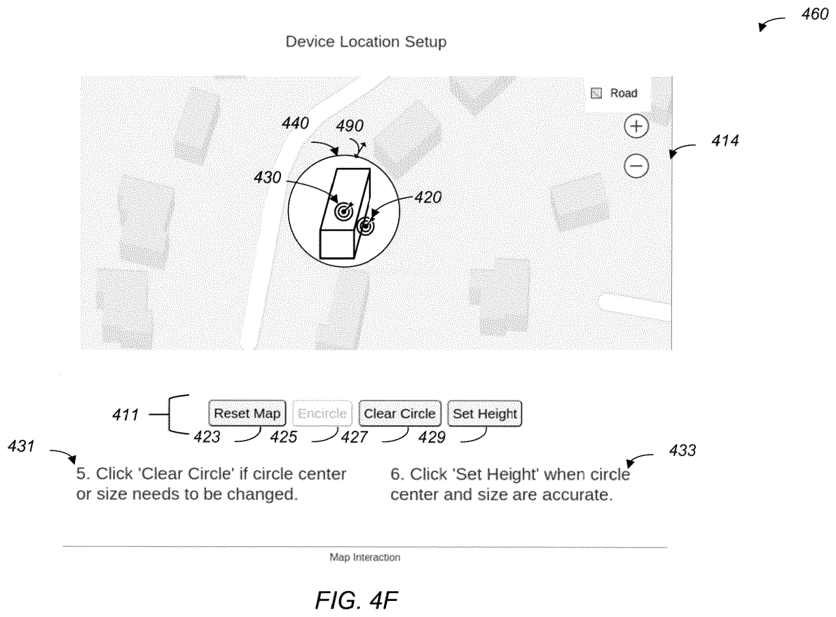

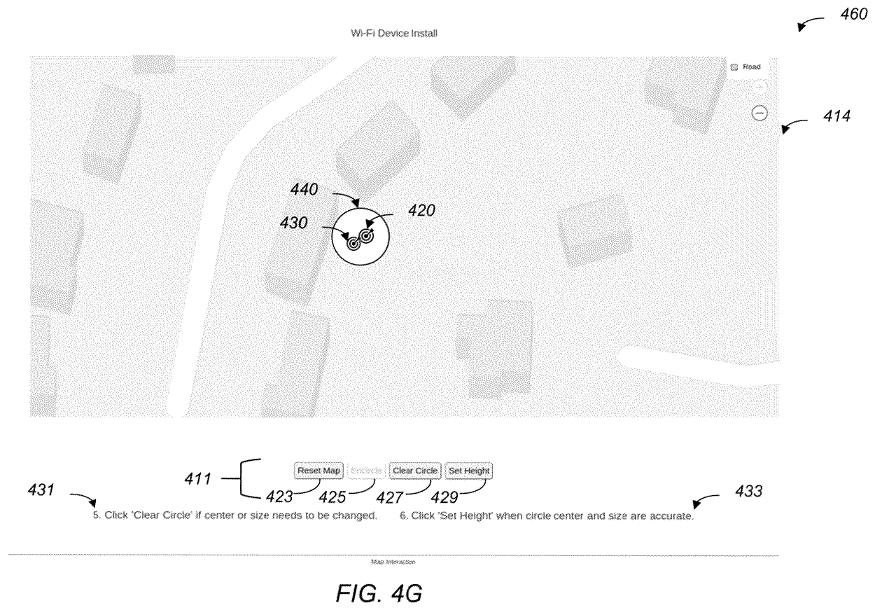

The user interface 29 includes, but is not limited to, push buttons, a keyboard, a keypad, a liquid crystal display (LCD), a thin film transistor (TFT), a light-emitting diode (LED), a high definition (HD) or other similar display device including a display device having touch screen capabilities so as to allow interaction between a user and the client device 4, for example, for a user to enter information associated with a location of a network device that can be stored in memory 31, such as any of an address, a height location, a floor, a story, and/or level, a latitude, a longitude, or any combination thereof of an access point device 2 as discussed with reference to FIG. 4. In one or more embodiments, user interface 29 provides an interface for a user, such as a graphical user interface, to interact with a provisioning application, for example, software 32, to provision or commission an access point device 2 to provide a 6 GHz wireless frequency band network. The network interface 30 can include, but is not limited to, various network cards, interfaces, and circuitry implemented in software and/or hardware to enable communications with the access point device 2, the extender access point device 3, ISP 1, and/or network resource 6 using any one or more of the communication protocols in accordance with connection 9 (for example, as described with reference to FIG. 1).

The memory 31 includes a single memory, one or more memories, or one or more memory locations that include, but are not limited to, a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), a hard disk or any other various layers of memory hierarchy. The memory 31 can be used to store any type of instructions, software, or algorithms including software 32 for controlling the general function and operations of the client device 4 in accordance with the embodiments described in the present disclosure. In one or more embodiments, software 32 can be a provisioning application. Memory 31 can store the provisioning application and information used by the provisioning application to provision an access point device 2 to utilize the 6 GHz wireless frequency band. In one or more embodiments, client device 4 is a network device, such as a mobile or smart phone configured to execute the provisioning application that comprises one or more instructions for determining a location associated with the access point device 2.

The controller 33 controls the general operations of the client device 4 and includes, but is not limited to, a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software including the software 32 for controlling the operation and functions of the client device 4 in accordance with the embodiments described in the present disclosure, such as provisioning access point device 2. Communication between the components (e.g., 28-31 and 33) of the client device 4 may be established using an internal bus 34.

The extender access point device 3 can be, for example, any wireless hardware electronic device used to extend a wireless network by receiving the signals transmitted by the access point device 2 and rebroadcasting the signals to any one or more client devices 4, which may be out of range of the access point device 2 including, but not limited to, a wireless extender, a repeater, and/or an access point. The extender access point device 3 can also receive signals from any one or more of the client devices 4 and rebroadcast the signals to the access point device 2 or any other one or more client devices 4.

As shown in FIG. 2, the extender access point device 3 includes a user interface 46, a power supply 47, a network interface 48, a memory 49, and a controller 51. The user interface 46 can include, but is not limited to, one or more push buttons, a keyboard, a keypad, an LCD, a TFT, an LED, an HD or other similar display device including a display device having touch screen capabilities so as to allow interaction between a user and the extender access point device 3. The power supply 47 supplies power to the internal components of the wireless extender access point device 3 through the internal bus 53. The power supply 47 can be connected to an electrical outlet (for example, either directly or indirectly by way of another device) via a cable or wire.

The network interface 48 can include various network cards, interfaces, and circuitry implemented in software and/or hardware to enable communications with the client device 4 and the access point device 2 using the communication protocols in accordance with connection 9 (e.g., as described with reference to FIG. 1). For example, the network interface 48 can include multiple radios or sets of radios (for example, a 2.4 GHz radio, one or more 5 GHz radios, and/or a 6 GHz radio), which may also be referred to as wireless local area network (WLAN) interfaces. One radio or set of radios (for example, 5 GHz and/or 6 GHz radio(s)) provides a backhaul connection between the wireless extender access point device 3 and the access point device 2, and optionally other wireless extender access point device(s) 3. Another radio or set of radios (for example, 2.4 GHz, 5 GHz, and/or 6 GHz radio(s)) provides a fronthaul connection between the extender access point device 3 and one or more client device(s) 4.

The memory 49 can include a single memory or one or more memories or memory locations that include, but are not limited to, a RAM, a DRAM, a memory buffer, a hard drive, a database, an EPROM, an EEPROM, a ROM, a flash memory, logic blocks of an FPGA, hard disk or any other various layers of memory hierarchy. The memory 49 can be used to store any type of instructions, software, or algorithm including software 50 associated with controlling the general functions and operations of the wireless extender access point device 3 in accordance with the embodiments described in the present disclosure.

The controller 51 controls the general operations of the wireless extender access point device 3 and can include, but is not limited to, a CPU, a hardware microprocessor, a hardware processor, a multi-core processor, a single core processor, an FPGA, a microcontroller, an ASIC, a digital signal processor (DSP), or other similar processing device capable of executing any type of instructions, algorithms, or software for controlling the operation and functions of the wireless extender access point device 3 in accordance with the embodiments described in the present disclosure. General communication between the components (for example, 46-51) of the extender access point device 3 may be established using the internal bus 53.

The access point device 2 can be, for example, any 6 GHz Wi-Fi device including, but not limited to, any of a hardware electronic device that can combine one or more functions of any of a modem, a gateway, an access point (AP), a router, or combinations thereof for providing content received from the content provider (ISP) 1 to network or wireless devices (for example, one or more extender access point devices 3, one or more client devices 4) in the system. It is also contemplated by the present disclosure that the access point device 2 can include the function of, but is not limited to, an IP/QAM STB, an SMD, or any other decoder that is capable of decoding audio/video content, and playing OTT or MSO provided content.

As shown in FIG. 2, the access point device 2 includes a user interface 20, a network interface 21, a power supply 22, a wide area network (WAN) interface 23, a memory 24, and a controller 26. The user interface 20 can include, but is not limited to, one or more push buttons, a keyboard, a keypad, an LCD, a TFT, an LED, an HD or other similar display device including a display device having touch screen capabilities so as to allow interaction between a user and the access point device 2. In one or more embodiments, the user interface 20 provides an interface, such as a command-line interface, a graphical user interface, an interface output port for connection to a display, and/or any other type of user interface. In one or more embodiments, access point device 2 communicates with a client device 4 to provide information associated with the access point device 2 such that the client device 4 can determine one or more location parameters via a provisioning application, according to one or more aspects of the present disclosure.

The network interface 21 may include various network cards, and circuitry implemented in software and/or hardware to enable communications with the extender access point device 3 and the client device 4 using the communication protocols in accordance with connection 9 (for example, as described with reference to FIG. 1). Additionally, the various network cards, interfaces, and circuitry of the network interface 21 enable communications with a client device 4 (for example, a mobile device) using the one or more communication protocols in accordance with connection 9 (for example, as described with reference to FIG. 1). For example, the network interface 21 can include an Ethernet port (also referred to as a LAN interface) and multiple radios or sets of radios (for example, a 2.4 GHz radio, one or more 5 GHz radios, and/or a 6 GHz radio, also referred to as WLAN interfaces). One radio or set of radios (for example, 5 GHz and/or 6 GHz radio(s)) provides a backhaul connection between the access point device 2 and the wireless extender access point device(s) 3. Another radio or set of radios (for example, 2.4 GHz, 5 GHz, and/or 6 GHz radio(s)) provides a fronthaul connection between the access point device 2 and one or more client device(s) 4. In one or more embodiments, the network interface 21 interfaces with a network resource 6.

The power supply 22 supplies power to the internal components of the access point device 2 through the internal bus 27. The power supply 22 can be connected to an electrical outlet (for example, either directly or by way of another device) via a cable or wire.

The wide area network (WAN) interface 23 may include various network cards, and circuitry implemented in software and/or hardware to enable communications between the access point device 2 and the ISP 1 using the wired and/or wireless protocols in accordance with connection 13 (for example, as described with reference to FIG. 1).

The memory 24 includes a single memory, one or more memories, or one or more memory locations that include, but are not limited to, a RAM, a DRAM, a memory buffer, a hard drive, a database, an EPROM, an EEPROM, a ROM, a flash memory, logic blocks of a FPGA, hard disk or any other various layers of memory hierarchy. The memory 24 can be a non-transitory computer-readable storage medium used to store any type of instructions, software, or algorithm including software 25 for providing a 6 GHz wireless frequency network based on provisioning by a client device 4.

The controller 26 controls the general operations of the access point device 2 as well as connectivity to the network by one or more other network devices (wireless extender access point devices 3 and client device 4). The controller 26 can include, but is not limited to, a central processing unit (CPU), a network controller, a hardware microprocessor, a hardware processor, a multi-core processor, a single core processor, a FPGA, a microcontroller, an ASIC, a DSP, or other similar processing device capable of executing any type of instructions, algorithms, or software including the software 25 in accordance with the embodiments described in the present disclosure. Communication between the components (for example, 20-24, and 26) of the access point device 2 may be established using the internal bus 27. The controller 26 may also be referred to as a processor, generally.

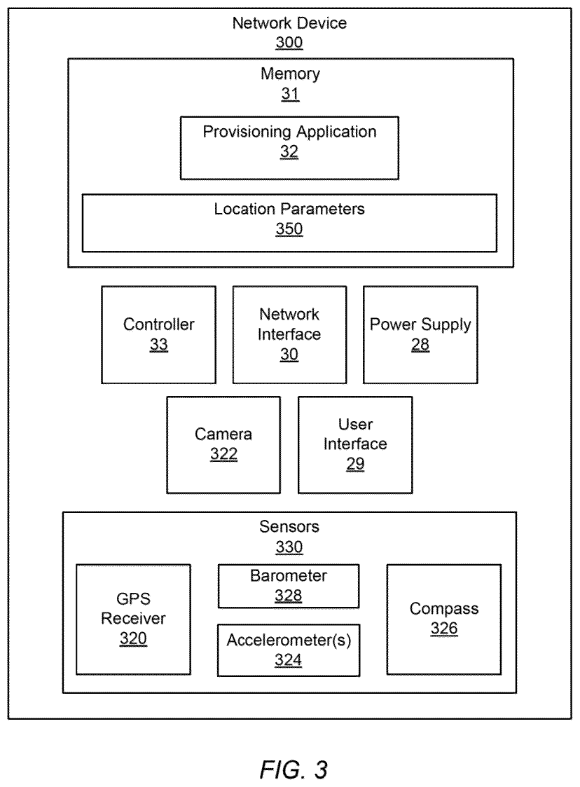

FIG. 3 is a more detailed block diagram illustrating certain components of an exemplary network device, for example, a client device 4, implemented in the network environment of FIG. 1 and in FIG. 2, according to one or more aspects of the present disclosure.

As shown in FIG. 3, the network device 300 includes a memory 31, a controller 33, a network interface 30, a power supply 28 (such as a rechargeable battery), a user interface 29, a camera 322 or any other device for receiving/recording a visual image, and one or more sensors 330. The one or more sensors 330 can include a global positioning system (GPS) receiver 320, one or more accelerometers 324, a compass or magnetometer 326, a barometer 328 (for example, to obtain a height location or measurement), any other sensor, or any combination thereof. In one or more embodiments, any of the one or more sensors 330 can be part of a single device or one or more devices. The memory 31 can be a computer-readable memory for storing software or one or more computer-readable instructions executable by the controller 33, for example, a provisioning application 32 and one or more provisioning parameters 350 for use by the provisioning application 32, for example, any of one or more measurements or data received from any of the one or more sensors 330, a camera 322, a user interface 29, or any combination thereof.

The provisioning application 32 can include one or more computer-readable instructions. The provisioning application 32 can be implemented by software, hardware, or a combination thereof. The provisioning application 32 can provide one or more location parameters 350 to an access point device 2 for use by the access point device 2 in obtaining a transmission power level. The one or more location parameters 350 are indicative of any of a location, a boundary, a height location, or any combination thereof of the access point device 2. The one or more location parameters 350 can be based on any of one or more measurements from any of the one or more sensors 330 and/or camera 322, one or more inputs received from a user interface 29 (such as any of a location, a boundary, a height location, or any combination thereof), or any combination thereof. For example, the one or more location parameters 350 can be based on any of an address, a height parameter (for example, indicative of a height above ground, above sea level, below ground, or below sea level of the access point device 2), a floor number or level of a building, a latitude, a longitude, or any combination thereof. The provisioning application 32 can be utilized to provide (such as send or transmit) one or more location parameters to one or more access point devices 2, one or more extender access point devices 3, any other network devices, and any combination thereof simultaneously, substantially simultaneous, or sequentially. The provisioning application 32 can discover the plurality of access point device 2 using, for example, a simple service discovery protocol (SSDP). As an example, a user can be prompted by the provisioning application 32 to select one or more access point devices 2 for provisioning and can be prompted to confirm the one or more location parameters 350 associated with each of the selected one or more access point devices 2.

In one or more embodiments, the user interface 29 includes a display and a graphical user interface or any other type of user interface. The provisioning application 32 can send one or more prompts to the user interface 29 that request information from or provide information to a user of the client device 4. For example, the user interface 29 can display a prompt to the user for information, such as one or more location parameters 350, associated with the access point device 2.

FIGS. 4A-4G illustrate a user interface of a provisioning application 32 for determining one or more location parameters 350 so as to allow for provisioning of a power transmission level for an access point device 2 in a network environment, according to one or more aspects of the present disclosure.

FIG. 4A illustrates an initial or introductory user interface 450 of the provisioning application 32 for providing (for example, transmitting or sending) one or more location parameters 350 to an access point device 2. The initial or introductory user interface 450 prompts the user to obtain an initial location of an access point device 2. An introduction 402 is provided to the user and along with a prompt to initiate provisioning, for example, via an obtain location response option 404, such as a button. In one or more embodiments, the provisioning application 32 can automatically obtain device identifier information associated with the access point device, such as any of a media access control (MAC) address, a serial number, any other information that uniquely identifies the access point device 2, or any combination thereof, and present the device identifier information to the user for the user to select so as to ensure that the user inputs received via the provisioning application 32 are for a specific access point device 2 to be provisioned. For example, a user can utilize the camera 322 to scan a quick response (QR) code on the access point device 2 that provides the provisioning application 32 with the device identifier information, input the user identifier information manually, use any other input mechanism or method, or any combination thereof.

FIG. 4B illustrates an address user interface 452 of the provisioning application 32 for providing (such as sending or transmitting) one or more location parameters 350 to an access point device 2. The address user interface 452 prompts the user with an address prompt or instruction 408 to enter a physical address 401 that comprises one or more fields, such as any of a street address, a city, a state, a zip code, or any combination thereof. The provisioning application 32 can obtain or receive the physical address 401, for example, as a text string. The physical address 401 can be any physical site or premises, such as any of a home, an office space, a building, a retail space, an outdoor space, any indoor space, or any combination thereof. While FIG. 4B illustrates specific fields for physical address 401, the present disclosure contemplates any one or more fields can be used to obtain an address associated with an access point device 2. The physical address 401 can be used by the provisioning application 32 to determine one or more coordinates (such as a location) associated with the physical address 401, for example, from a network resource including, but not limited to, any of a map application, a GPS application, a national repository, any other application and/or repository, or any combination thereof. For example, a get coordinates response option 406, such as a button, can be provided to the user so as to initiate a query to obtain the one or more coordinates associated with the physical address 401 as an initial location for the access point device 2.

In one or more embodiments, the provisioning application 32 obtains an initial location associated with the client device 4, such as a mobile phone, without requiring a user to enter a physical address 401. For example, the provisioning application 32 can determine the initial location associated with a client device 4 based on one or more coordinates received from the GPS receiver 320 or any other application, service, and/or device that provides at least longitude and latitude coordinates associated with the client device 4. This is initial location can be provided to a user via a user interface. In one or more embodiments, the user can accept this initial location as the location of the access point device 2 such that one or more location parameters 350 associated with the access point device 2 are based on this initial location.

The physical address 401 can be pre-filled based on any of previously stored user location information and/or account information, based on an address determined by information received from a GPS receiver 320, a compass 326, a barometer 328, an accelerometer 324, any other sensor, any other address service, or any combination thereof. In one or more embodiments, the user is permitted to alter or change the pre-filled physical address 401. In one or more embodiments, the user can be prompted with an indoor/outdoor response option that indicates an indoor location or an outdoor location of the access point device 2. In one or more embodiments, the indoor/outdoor response option can be determined based on a type of access point device 2. As an example, indoor/outdoor response option can be used to indicate that the location determined for the access point device 2 is an indoor location such that a higher transmission power level can be obtained by the access point device 2 as compared to a power transmission power level for an outdoor location. The indoor location or the outdoor location indicated by the indoor/outdoor response option can be sent to the access point device for transmitting to the AFC. For example, if an outdoor location is indicated the AFC may return a power level lower than that for an indoor location, including a power level below the low power indoor (LPI) level.

FIG. 4C illustrates a height location user interface 454 of the provisioning application 32 for obtaining or receiving a height location. The height location user interface 454 provides a height location selection instruction 410 to a user so as to select one or more height parameters 409. For example, a user can be presented with any of one or more height response options 403, for example, that indicate a floor, a story, and/or a level of a premises or site, a minimum and/or maximum height input 405, any other height indicator, or any combination thereof. In one or more embodiments, the height location is based on the one or more height parameters 409. While FIG. 4C illustrates options for selecting a height above sea level or above ground, the present disclosure contemplates selecting a depth below sea level or a depth below ground, such as a one or more basement or garage levels. The height location is based on the one or more height parameters to the one or more height location response options received from the user. In one or more embodiments, the height location can be indicative of or used to determine a vertical or height uncertainty.

The provisioning application 32 can determine that a new location and/or the height location is within a location threshold of the initial location of the client device 4. As an example, the provisioning application 32 can compare the initial location to the new location and based on that comparison determine whether the location threshold has been reached or exceeded such that the initial location is not within a location threshold of the new location. In one or more embodiments, the provisioning application 32 prior to, upon, or after receiving a new location and/or the height location can determine that the client device 4 is within a proximity threshold of the access point device 2. For example, the access point device 2 can send the provisioning application a confirmation based on any of the client device being connected via a service set identifier (SSID) to the access point device 2, a receive signal strength indicator (RSSI), IEEE 802.11mc, unassociated station measurements, any other indicator, or any combination thereof. If the client device 4 associated with the provisioning application 32 is not within the proximity threshold, the provisioning application 32 will not receive a confirmation from the access point device 2 and the access point device 2 will not verify or otherwise use the one or more location parameters from the provisioning application 32, for example, the access point device 2 will not send the one or more location parameters to a network resource so as to obtain a transmission power level. In one or more embodiments, the proximity threshold can be a range of up to a few tens of meters. In one or more embodiments, FIG. 4C can be omitted and the height location can be provided by any of a barometer 328, a GPS receiver 320, any other sensor, any other source and/or service that provides a height parameter, or any combination thereof. In one or more embodiments, one or more height parameters are pre-filled in FIG. 4C and the user is permitted to change or alter the one or more pre-filled height parameters so as to indicate a height location of the access point device 2. In one or more embodiments, the provisioning application 32 determines whether the client device 4 is within a proximity threshold of the access point device 2, initial location is within a location threshold of the new location, or both. The client device 4 can send the one or more location parameters to the access point device 2 based on these determinations, for example, that the client device is within the proximity threshold of the access point device, the initial location is within the location threshold of the new location, or both.

The height location user interface 454 can present the user with a write location user response 412, such as a button. When the user selects the write location user response 412, the provisioning application 32 provides (for example, sends or transmits) one or more location parameters to the access point device 2. The one or more location parameters can be based on the height location, the initial location, a new location, or any other location information associated with the access point device 2. While FIG. 4C illustrates a write location user response 412, the present disclosure contemplates that any user interface of FIGS. 4B-4G can present the user with a write location user response 412 so as to allow a user to provide one or more location parameters to the access point device 2.

FIG. 4D illustrates an interactive location user interface 456 of the provisioning application 32 for determining one or more location parameters 350. The interactive location user interface 456 determines the one or more location parameters 350 for example, from any of Fig. B, Fig. C, using any application, repository, service, and/or device that provides coordinates associated with a network device obtained by the provisioning application 32, or any combination thereof so as to display a visual representation of the location 420 of the access point device 2, for example, using a map representation 414. In one or more embodiments, the map representation 414 comprises a silhouette or other indicator for one or more structures at or about the location 420. The interactive location user interface 456 provides the user with interactive instructions 415 and 417 so as to inform the user regarding one or more interactive processes, such as that the location 420, for example, an initial location, of the access point device 2 can be updated, adjusted, altered or otherwise changed using any of an interactive interface, for example, any of a drag, a resize, a multi-touch gesture, a point and/or multi-point select, any other interact tool, or any combination thereof. For example, a user can select a radial point about the location 420 and drag the radial point to indicate a new location associated with the access point device 2, such as any of select a circle where the radius can be increased or decreased so as to encircle the location 420, select one or more points or indices about the location so as to indicate a boundary for the location 420, select any other shape or indicator to indicate an area of the location 420, or any combination thereof. The interactive location user interface 456 can provide one or more command responses 411, such as any of a reset map response 423 (for example, to re-center the location 420), an encircle response 425 (for example, to provide a user interface indicator for the selected location, such as to proceed to FIG. 4E), a clear response 427 (for example, to clear the selected area for the location 420), a set height response 429 (for example, to set a height of the location 420), or any combination thereof. In one or more embodiments, a user can advance to FIG. 4E by selecting a set height response 429 or any other response, such as an enter or select response.

FIG. 4E illustrates an interactive location user interface 458 similar to FIG. 4D except that one or more user instructions 419 and 421 are provided so as to inform the user regarding a selection of a boundary or area associated with the location 420, for example, to identify a boundary or area by encircling the location 420, using one or more interactive processes as discussed with reference to FIG. 4D of the provisioning application 32 for providing one or more location parameters 350 based on the location 420 (such as the new location), the boundary, and the height location. For example, the one or more user instructions 419 and 421 can instruct the user on how to change the area or boundary associated with the location 420. As illustrated in FIG. 4F, for example, an interactive location user interface 460 can be presented or displayed. The interactive location user interface 460 is similar to the interactive location user interface 458 of FIG. 4E except FIG. 4F illustrates one or more user instructions 431 and 433 that indicate to the user how to clear the area or boundary 440 and how to proceed to set the height location of the location 420 (if not previously set as indicated in FIG. 4C). The interactive location user interface 460 allows the user to change, update, alter, or otherwise denote a different area or boundary 440. For example, the user can utilize an interact tool 490 so that the area or boundary 440 can be resized, altered, or otherwise changed based on interaction by the user with the interact tool. The provisioning application 32 receives a new location and a boundary based on an interaction with the interact tool 490 by the user. Upon interaction by the user, the location 420 (an initial location, for example) is then recentered to location 430 (a new location, for example) so that the location of the access point device 2 is indicated as being in the center of the area or boundary 440 based on the interaction of the user. For example, the interaction of the user can expand a boundary 440, shrink a boundary 440, select an endpoint or one or more indices, or any combination thereof. FIG. 4F illustrates the user repositioning the location 420 (for example, at an entrance to a building) to location 430 (for example, to a center of the building). In one or more embodiments, as illustrated in FIG. 4G, the user can reposition the location 420 to a location 430 so as to set a boundary or area 440 that accurately sets the location to an outdoor location. The one or more location parameters based on the location 430, the boundary, and the height location, or any updated location (for example, based on the address, a location 420 and/or a location 430), or any combination thereof can be provided to the access point device 2.

While FIGS. 4A-4G are presented in a certain order, the present disclosure contemplates that any one or more of the FIGS. 4A-4G can be implemented in any order, repeated or omitted. In one or more embodiments, prior to initiating or presenting one or more of FIGS. 4A-4G to the user, the provisioning application can determine that the client device 4 associated with the provisioning application 32 is locally connected to the access point device 2. If not locally connected, the provisioning application 32 can indicate to the user that access to the provisioning application 32 for providing a location and/or one or more location parameters to the access point device 2 is not permitted. In one or more embodiments, after the provisioning application 32 provides the one or more location parameters to the access point device 2, the access point device 2 can determine that the one or more location parameters are no longer valid and can send a notification message to the user requesting one or more new location parameters via any of the provisioning application 32 using in-application messaging, cloud messaging, a push service, an email, a text messaging service, any other communication service, or any combination thereof.

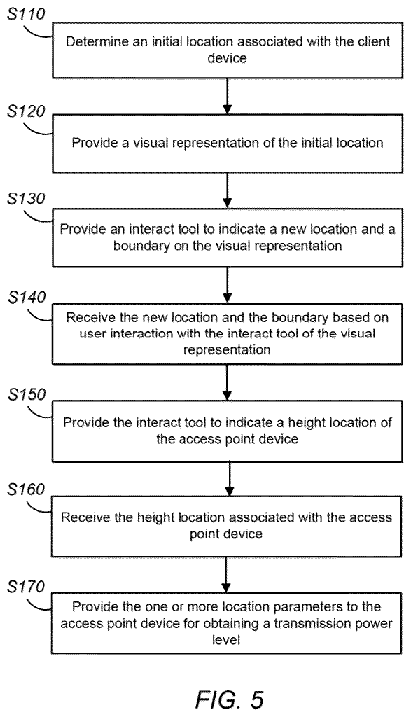

FIG. 5 is a flow chart illustrating a method for determining one or more location parameters associated with an access point device of a network, according to one or more aspects of the present disclosure. The client device 4 may be programmed with one or more computer-readable instructions such as a provisioning application 32 that when executed by a controller 33 cause the client device 4 to provide one or more location parameters to an access point device 2, according to one or more embodiments, so as to provide an enhanced QoE for users of a network environment by allowing a user to select the location and height of the access point device 2. In FIG. 5, it is assumed that any one or more of the devices include their respective controllers and their respective software stored in their respective memories, as discussed above in connection with FIGS. 1-4, which when executed by their respective controllers perform the functions and operations in accordance with the example embodiments of the present disclosure (for example, including performing a configuration of one or more network devices). While the steps S110-S170 are presented in a certain order, the present disclosure contemplates that any one or more steps can be performed simultaneously, substantially simultaneously, repeatedly, in any order or not at all (omitted).

At step S110, a provisioning application 32 of a client device 4, for example, a mobile phone, can determine an initial location associated with the client device 4. As an example, a user with a mobile phone can be disposed or positioned at or about an access point device 2. The user can launch or initiate the provisioning application 32 loaded on the mobile phone. The provisioning application 32 upon being launched or initiated can determine the initial location of the mobile phone, such as by any of receiving one or more coordinates received from a GPS receiver 320 of the mobile device, accessing a network resource that provides one or more coordinates, any other system and/or method for obtaining one or more coordinates associated with the location of the mobile phone, or any combination thereof. In one or more embodiments, the determining an initial location comprises any of pre-filling the initial location as an address 401 (as illustrated and discussed with reference to FIG. 4B) and prompting the user for confirmation, receiving an address 401 from the user based on an address prompt 408, any other receiving and/or prompting a user for the initial address, or any combination thereof. For example, an address 401 can be pre-filled, the address can be filled in by the user (such as a user input), or both. In one or more embodiments, prior to step S110 or any other step S120-S170, the provisioning application 32 can determine that the client device 4 is within a proximity threshold of the access point device 2 so as to ensure that the client device 4 is located at or about the access point device 2, for example, to prevent inaccurate, malicious, and/or inadvertent location determination by the client device 4.

At step S120, the provisioning application 32 provides a visual representation of the initial location of the client device 4 to the user. For example, the provisioning application 32 can present via a display of the client device 4 and/or a display connected to the client device 4 a graphical user interface (GUI) that provides a symbolic representation, such as a map, of the initial location of the client device 4. While the present disclosure provides exemplary visual representations in FIGS. 4D-4G, the present disclosure contemplates that any visual representation capable of presenting a symbolic representation of the initial location.

At step S130, the provisioning application 32 provides an interact tool for the user to indicate a new location and a boundary associated with the access point device based on the visual representation. In one or more embodiments, the provisioning application 32 automatically, via the visual representation, indicates an outline for a premises for a user to confirm as the new location, the boundary or both. In one or more embodiments, the boundary can be the same as the new location, for example, a user can indicate with the interact tool the same area for the boundary as the initial location. While the present disclosure provides an interact tool 490 at FIG. 4F, the present disclosure contemplates any type of interact tool that allows a user to select a boundary at or about a point of the visual representation, such as the initial location. An interact tool can provide for resizing of a shape, such as an oval or ellipse, a circle, a square, a rectangle, or any other shape that is resizable, so as to expand or decrease a boundary. The interact tool allows a user to fine-tune the one or more location parameters associated with an access point device 2 so that the location of the access point device 2 is based on more accurate information.

At step S140, the provisioning application 32 receives the new location and the boundary based on user interaction with the interact tool of the visual representation as provided in step S130. For example, the user can use the interact tool to select the new location and the boundary. The new location and boundary can be the same, for example, the user does not indicate a perimeter associated with operation of the access point device 2. In one or more embodiments, receiving the new location and the boundary comprises determining or receiving one or more coordinates associated with the new location and/or the boundary.

At step S150, the provisioning application 32 provides an interact tool to indicate a height location of the access point device. The interact tool can be a user interface that allows the user to select one or more location parameters as discussed with respect to FIG. 4C, a location within an outline as discussed with reference to FIG. 4F (for example, to indicate a ground floor location or a different floor location), or both. At step S160, the provisioning application can receive a height location associated with the access point device 2 based on step S150. For example, the provisioning application 32 can determine a height location associated with the access point device 2 based on one or more height parameters received from a user, for example, as illustrated and discussed with reference to FIG. 4C. In one or more embodiments, the one or more height parameters are received from the user based on the address 401. For example, the user can enter an address 401 with a height indicator, such as any of a suite number, a unit number, an apartment number, any other height indicator of the story, the floor or the level, or any combination thereof and the one or more height parameters correspond to the height indicator. In one or more embodiments, determining the height location comprises determining any of a height above sea level (for example, an altitude), a height above ground (for example, an elevation), a depth below sea level, a depth below ground, a vertical or height uncertainty, or any combination thereof based on the one or more height parameters. The height location can be received from a user via selection of a location using the interact tool as discussed with reference to FIG. 4F. The height location can indicate a vertical coordinate (above or below ground or sea level) associated with the access point device 2. In one or more embodiments, the height location can comprise any of a default height location, a pre-populated height location based on an initial location (for example, a GPS height or barometer reading), a user response associated with a prompt for a height location (for example, receiving a response, an adjustment to a pre-populated height location from a user interface, or both), or any combination thereof.

The provisioning application 32 can determine the one or more location parameters associated with the access point device 2 based on the height location, the new location, and the boundary. Determining the one or more location parameters comprises any of receiving the one or location parameters from a network resource 6, such as a repository, utilizing locally or remotely stored any of information, application, interface, service, any other utility, or any combination thereof to determine the one or more location parameters, or both. The one or more location parameters can comprise one or more coordinates, such as any of a longitude coordinate, a latitude coordinate, a vertical coordinate, or any combination thereof. In one or more embodiments, the provisioning application 32 determines whether the new location is within a location threshold of the initial location. For example, an access point device 2 can be positioned or disposed at a premises or site. The provisioning application 32 can determine based on one or more coordinates associated with the new location and the boundary whether one or more initial coordinates associated the mobile phone is within a location threshold of the new location. Generally, a user with a mobile phone is in the same room, within a few meters, or up to a few tens of meters of the access point device 2.

The one or more location parameters associated with the access point device 2 can be based on the new location, the boundary, and the height location. For example, the one or more location parameters can indicate GPS coordinates that can comprise an x-, y-, and/or z-coordinate such that the location can comprise a longitude coordinate (x-coordinate), a latitude coordinate (y-coordinate) and a vertical coordinate (z-coordinate). The present disclosure contemplates that the z-coordinate can indicate an altitude and/or an elevation or a depth below sea level or ground level (a negative z-coordinate). In one or more embodiments, the provisioning application 32 can convert any one or more of the location parameters to a specific coordinate system or any other location indicator.

At step S170, the provisioning application 32 provides the one or more location parameters to the access point device 2. The access point device can then use the one or more location parameters to obtain a transmission power level. The providing the one or more location parameters can comprise common protocols such as transmission control protocol (TCP)/internet protocol (IP), hypertext transmission protocol secure (HTTPS), or any other protocol. The providing can be direct on a local network or indirect via cloud network. The one or more location parameters can be based on any of the initial location, the new location, the height location, an indoor location, an outdoor location, or any combination thereof and can be stored local to or remote from the client device 4, for example, at a network resource 6. In one or more embodiments, the one or more location parameters are provided to one or more other access point devices 2 in the network for obtaining the transmission power level. For example, the provisioning application 32 can discover one or more network devices that require provisioning with a transmission power level. The location can then be transmitted to any one or more of the one or more network devices, such as one or more other access point devices 2 for obtaining a transmission power level as the one or more location parameters associated with the access point device 2 can be the same or similar (for example, within an error threshold) to each actual location associated with the one or more network devices.

According to one or more example embodiments of inventive concepts disclosed herein, there are provided novel solutions for providing one or more location parameters to an access point device 2 so that a network environment can utilize a 6 GHz frequency band which can provide an enhanced QoE for a user.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. A method for providing one or more location parameters associated with an access point device of a network comprising:
determining an initial location associated with the client device;
providing a visual representation of the initial location to a user;
providing an interact tool for the user to indicate a new location and a boundary associated with the access point device on the visual representation;
receiving the new location and the boundary based on user interaction with the interact tool of the visual representation;
receiving a height location associated with the access point device; and
providing one or more location parameters to the access point device for obtaining a transmission power level, wherein the one or more location parameters are based on the new location, the boundary, and the height location.

2. The method of claim 1, wherein determining the initial location comprises:
receiving an address based on an address prompt, wherein at least one of:
the address is pre-filled; and
the address is filled in by the user.

3. The method of claim 1, wherein determining the initial location is based on one or more coordinates received from a GPS receiver of the client device.

4. The method of claim 1, wherein the height location indicates any of a height above sea level, a height above ground, a depth below sea level, a depth below ground, a vertical uncertainty, or any combination thereof.

5. The method of claim 1, further comprising at least one of:
determining that the new location is within a location threshold of the initial location; and
determining that the client device is within a proximity threshold of the access point device.

6. The method of claim 1, further comprising:
providing the interact tool to indicate a height location of the access point device.

7. The method of claim 1, further comprising:
discovering one or more other access point devices of the network; and
providing the one or more location parameters to the one or more other access point devices for obtaining a transmission power level.

8. A non-transitory computer-readable medium storing one or more instructions for providing one or more location parameters associated with an access point device of a network, that when executed by a processor, cause the processor to perform one or more operations comprising:
determining an initial location associated with the client device;
providing a visual representation of the initial location to a user;
providing an interact tool for the user to indicate a new location and a boundary associated with the access point device on the visual representation;
receiving the new location and the boundary based on user interaction with the interact tool of the visual representation;
receiving a height location associated with the access point device; and
providing one or more location parameters to the access point device for obtaining a transmission power level, wherein the one or more location parameters are based on the new location, the boundary, and the height location.

9. The non-transitory computer-readable medium of claim 8, wherein determining the initial location comprises receiving an address from the user based on an address prompt, wherein at least one of:
the address is pre-filled; and
the address is filled in by the user.

10. The non-transitory computer-readable medium of claim 8, wherein determining the initial location is based on one or more coordinates received from a GPS receiver of the client device.

11. The non-transitory computer-readable medium of claim 8, wherein the height location indicates any of a height above sea level, a height above ground, a depth below sea level, a depth below ground, a vertical uncertainty, or any combination thereof.

12. The non-transitory computer-readable medium of claim 8, wherein the one or more computer-readable instructions when executed by the processor, further cause the processor to perform the one or more operations further comprising at least one of:
determining that the new location is within a location threshold of the initial location; and
determining that the client device is within a proximity threshold of the access point device.

13. The non-transitory computer-readable medium of claim 8, wherein the one or more computer-readable instructions when executed by the processor, further cause the processor to perform the one or more operations further comprising:
providing the interact tool to indicate a height location of the access point device.

14. The non-transitory computer-readable medium of claim 8, wherein the one or more computer-readable instructions when executed by the processor, further cause the processor to perform the one or more operations further comprising:
discovering one or more other access point devices of the network; and
providing the one or more location parameters to the one or more other access point devices for obtaining a transmission power level.

15. A network device for determining a location of an access point device of a network comprising:
a memory storing one or more computer-readable instructions; and
a processor configured to execute the one or more computer-readable instructions stored on the memory to cause the network device to:
determine an initial location associated with the network device;
provide a visual representation of the initial location to a user;
provide an interact tool for the user to indicate a new location and a boundary associated with the access point device on the visual representation;
receive the new location and the boundary based on user interaction with the interact tool of the visual representation;
receive a height location associated with the access point device; and
provide one or more location parameters to the access point device for obtaining a transmission power level, wherein the one or more location parameters are based on the new location, the boundary, and the height location.

16. The network device of claim 15, wherein at least one of:
the determining the initial location comprises receiving an address from the user based on an address prompt, wherein at least one of:
the address is pre-filled; and
the address is filled in by the user; and
the determining the initial location is based on one or more coordinates received from a GPS receiver of the network device.

17. The network device of claim 15, wherein the height location indicates any of a height above sea level, a height above ground, a depth below sea level, a depth below ground, a vertical uncertainty, or any combination thereof.

18. The network device of claim 15, wherein the processor is further configured to execute the one or more computer-readable instructions to cause the network device to at least one of:
determine that the new location is within a location threshold of the initial location; and
determine that the network device is within a proximity threshold of the access point device.

19. The network device of claim 15, wherein the processor is further configured to execute the one or more computer-readable instructions to cause the network device to provide the interact tool to indicate a height location of the access point device.

20. The network device of claim 15, wherein the processor is further configured to execute the one or more computer-readable instructions to cause the network device to:
discover one or more other access point devices of the network; and
provide the one or more location parameters to the one or more other access point devices for obtaining a transmission power level.
